(19) United States
(12) Patent Application Publication
(10) Pub. No.: US 2019/0353089 A1
(43) Pub. Date: Nov. 21, 2019

(54) INTERNAL COMBUSTION ENGINE

(71) Applicant: MOTODAN LIMITED, Coventry (GB)

(72) Inventor: Dan MERRITT, Coventry (GB)

(73) Assignee: Motodan Limited, Coventry (GB)

(21) Appl. No.: 16/461,610

(22) PCT Filed: Nov. 4, 2016
(86) PCT No.: PCT/GB2016/000199

§ 371 Date: May 16, 2019

(30) Foreign Application Priority Data
Nov. 17, 2015 (GB) 1520221.1
Jan. 19, 2016 (GB) 1600971.4
Mar. 23, 2016 (GB) 1604930.6
Jul. 28, 2016 (GB) 1613034.6

(51) Int. Cl. F02B 19/10; F02B 19/18; F02B 19/12; F02B 19/08; F02P 13/00

(52) U.S. Cl. CPC F02B 19/1071; F02B 19/108; F02P 13/00; F02B 19/12; F02B 19/08; F02B 19/18

(57) ABSTRACT

A method of operating the stratified charge Merritt Engine described in WO2005/052335 and WO2007/0830366 enabling new benefits such as full compliance with NOx emission regulations, control over peak pressures, increased power density, and high fuel economy all enabled by preprogramming the timing of the gasoline direct fuel injection process.

### CROSS-REFERENCE TO RELATED APPLICATIONS

This application is a National Stage Application of PCT/GB2016/000199 filed Nov. 4, 2016 which claims priority of GB1520221.1 filed Nov. 17, 2015 and GB1600971.4 filed Jan. 19, 2016 and GB1604930.4 filed Mar. 23, 2016 and GB1613034.6 filed Jul. 28, 2016.

### BACKGROUND OF THE INVENTION

### 1. Field of the Invention

The present invention relates to an internal combustion engine, but more particularly to controlling its operation to reduce or minimize output of pollutant gases.

### 2. The Prior Art

Various internal combustion engines which can be classified as stratified charge engines invented by the inventor herein are known for example from international publications WO 2005/0523355 and WO/2007/080366. Those engines are now recognized in the literature as Merritt Engines.

The main constructional characteristic of the Merritt Engine resides in use of a separate combustion chamber spaced away from the cylinder to avoid burning fuel in the region of the cylinder above the piston. The Merritt Engine like the Otto engine uses spark ignition and gasoline or other volatile liquid hydrocarbons as fuel. It can operate either on the four-stroke or on the two-stroke engine cycle.

The use of such a separate combustion chamber allows the Merritt engine to stratify the air/fuel mixture, enabling reliable spark ignition without throttling the air intake. This, coupled with rapid combustion resulting from vortex motion in the combustion chamber, as well as lower radiation heat loss from burning gases, promote higher thermal efficiency at part load compared with throttled engines such as the Otto gasoline engine. When operating unthrottled, the Merritt Engine uses more air than is needed for complete combustion at part load and therefore has free Oxygen present in its exhaust gases. The Merritt Engine is suitable for use in automotive and motor-cycle applications and therefore it needs to meet legislated exhaust emission limits which can differ country by country.

The present invention provides two new methods of operation for the Merritt type engine, which methods can be used singly or in combination. When combined, the present methods enable the exhaust gas to be substantially Oxygen free enabling use of a catalytic converter to remove offending quantities of Nitrogen Oxides from the exhaust gases, which will be referred to as NOx for short. Because NOx only appears in the Merritt Engine's exhaust at higher indicated means effective pressures (IMEP) values, both methods are preferably deployed together only under such operating conditions, and they are preferably devised to be applied or disengaged whilst the engine is operating. Removal of excess Oxygen from the combustion chamber can be effected by one of the two methods which is partial throttling of the engine's air intake but this preferably is arranged only to take place at higher indicated mean effective pressure (IMEP) values. A second problem requires removal of free Oxygen from the bump clearance. The bump clearance is the volume remaining in the cylinder above the piston at the end of the compression stroke which, even when minimized, contains an appreciable amount of Oxygen because of high gas density, ten percent is a realistic example. Since the Merritt Engine has a separate combustion chamber this Oxygen is normally unusable for combustion purposes. The Merritt Engine relies on a GDI (gasoline direct injector) fuel injector situated in the separate combustion chamber and its fuel spray cone is discharged towards the far end of that combustion chamber, away from the cylinder.

This aspect of the invention provides an effective solution to the bump clearance Oxygen removal problem by another method of engine operation that focuses upon a modified fuel injection process. This method when used on its own can also offer other advantages to the Merritt engine, in addition to NOx reduction or removal.

### SUMMARY OF THE INVENTION

The present invention seeks to provide a modified internal combustion engine, improved methods of operating same, and motor vehicles fitted with such an engine.

Accordingly, this invention provides an internal combustion engine comprising; a cylinder; a cylinder head to close the cylinder at one end; a piston located in the cylinder for reciprocating movements therein; an unavoidable bump clearance volume in the cylinder situated above the piston when the piston reaches the end of the compression stroke; air inlet means communicating with the cylinder for intake of air into the engine; exhaust means communicating with the cylinder; a combustion chamber within the cylinder head having a near end and a far end relative to the cylinder, said chamber being spaced from the cylinder but communicating therewith at its near end; a transfer orifice communicating with the cylinder and the combustion chamber at its near end positioned to deliver a jet of air into the combustion chamber with a tangential velocity component during the compression stroke of the piston; means to promote an axial velocity component to swirling air motion generated within the combustion chamber; fuel injection means communicating with the combustion chamber at its near end arranged to deliver liquid fuel spray towards the far end of the chamber and into the air jet; at least one ignition means in the region of the far end of the combustion chamber; a controller to control at least the fuel injection process, the ignition process, and the air intake processes; wherein, a primary method of operation of said engine can be activated by the controller enabling diversion of a controlled amount of fuel from the fuel injector outlet in the separate combustion chamber into that cylinder volume above the piston, after the ignition means in the combustion chamber ignites the fuel therein and can continue until after the piston commences its expansion stroke and/or a secondary method of engine operation is activated by the controller, comprising partial restriction of air intake to the engine to minimize or avoid free Oxygen in the combustion chamber and bump clearance after the fuel inside the engine is burnt.

Preferably the combustion chamber is configured to induce or enhance swirling flow of air when delivered therein. The combustion chamber could operate as a vortex tube. The combustion chamber could be cylindrical, conical or part-conical in shape, for example.

The air inlet means can also include a throttle valve situated upstream of an inlet valve to bring into effect the said secondary method of operation.

The ignition means typically comprise a spark plug. The exhaust means can also include a catalytic converter capable of Nitrogen Oxides removal situated downstream of an exhaust valve.

The term clearance volume means the sum of the volume within the combustion chamber plus the bump clearance volume.

The term TDC (top dead center) describes the position of the piston at the end of its compression stroke.

The term BDC (bottom dead center) describes the position of the piston at the end of its expansion stroke.

The term swept volume describes the volume contained in the cylinder between the TDC and BDC piston positions. The term NOx means Nitrogen Oxides gases as are typically contained in the exhaust gases.

The term IMEP describes the indicated means effective pressure developed in the cylinder, and is indicative of engine's load and torque output. The term peak pressure describes the maximum cylinder pressure achieved during an engine cycle.

The term constant volume combustion describes a very rapid fuel burn process where the whole combustion process takes place within a few crank angle degrees near TDC. The term thermal efficiency describes the ratio between the work energy output and the heat energy input during the same number of engine cycles;

The term stratification describes a fuel/air mixture preparation process which deliberately avoids formation of a homogeneous mixture in the combustion chamber and instead creates a zoned mixture formation where a rich zone containing relatively more fuel is placed near the spark plug to enable spark ignition and a weak zone containing less fuel or even no fuel at all, arises elsewhere in the combustion chamber spaced away from the spark plug. The spark ignites the mixture in the rich zone and the energy produced by the flame is sufficient to ignite fuel in the weak zone. The Merritt Engine produces a very effective stratification system which allows it to operate completely unthrottled when use of a catalytic converter is not required.

### BRIEF DESCRIPTION OF THE DRAWINGS

In order that the invention in all its aspects may be illustrated, more easily appreciated and readily carried into effect by those skilled in the art, embodiments will now be described herein purely by way of non-limiting examples with reference to the accompanying three schematic diagrams which are not drawn to scale and are presented for illustrative purposes only, wherein:

FIG. 1 is a sectional view through part of a Merritt type internal combustion engine cylinder and cylinder head arrangement, with throttle valve fully opened (unthrottled),

FIG. 2 is a view similar to FIG. 1, illustrative of the secondary method of operation with throttle valve partially closed.

FIG. 3 is a view similar to FIG. 1 with piston commencing travel away from TDC and so illustrative of the primary and secondary methods of operation of the engine.

### DETAILED DESCRIPTION OF THE PREFERRED EMBODIMENT

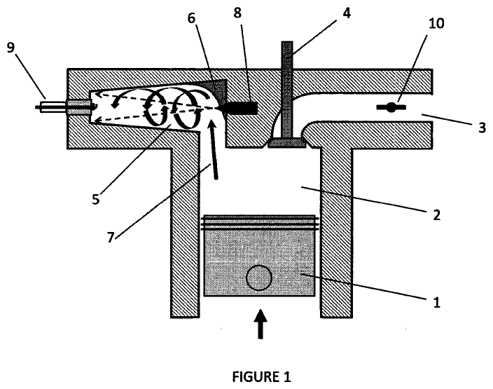

FIG. 1 is also used to explain the engine components. The engine shown needs to be equipped with a throttle valve which is shown and also a catalytic converter which is not shown in the drawings. These two items are only needed to remove NOx pollutants under certain conditions but are not essential for the operation of the engine which can operate, without utilizing the new methods according to this invention, as an unmodified Merritt Engine with a fully open throttle valve. FIG. 1 shows the engine when not utilizing the new operational methods according to this invention. Piston (1) is shown in the middle of the compression stroke in cylinder (2) when operating at approximately 25% of its maximum IMEP with an overall air/fuel ratio of approximately 60 to one.

Over this lower end of IMEP the engine does not produce much NOx exhaust emissions and can therefore operate unthrottled, within allowed NOx emission limits, to deliver high thermal efficiency as an unmodified Merritt Engine. The throttle valve (10) is shown fully open. The fuel injector (8) is shown delivering a cone of liquid fuel towards spark plug (9) at the far end of the combustion chamber. The transfer Orifice (7) shows a streamline of air entering the combustion chamber (5) to form a fierce vortex type swirling air motion and a helical ramp (6) is shown imparting an axial component to the swirling gases directed towards the spark plug, a motion which can be described as helical swirl. One breathing valve (4) is shown in the closed position during the compression stroke downstream of the throttle valve (10), it is the air inlet means. A catalytic converter will be situated in the exhaust pipe of engines according to all three figures although it is not shown because the inlet pipe (3) is shown in preference to exhaust outlet to illustrate the variable position of the throttle valve (10).

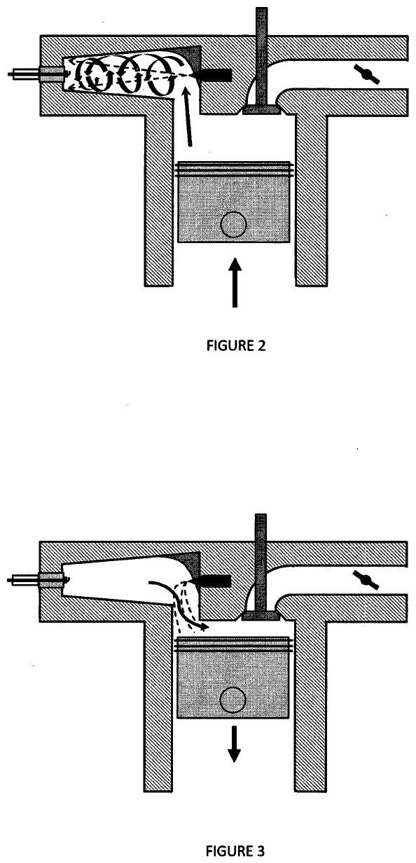

FIG. 2 also illustrates the piston during the compression stroke as does FIG. 1 but the throttle valve (10) is shown in a partially closed position and the engine is operating at an increased fuelling rate at approximately 80% of its maximum IMEP, when the amounts of NOx gases produced during combustion exceed allowed emission limits. In FIG. 3 the engine of FIG. 2 is shown a short time later when the piston has started moving during its expansion stroke.

It should be appreciated that the Merritt Engine's stratified charge combustion system enables it to completely burn any amount of fuel within the combustion chamber in the presence of any amount of excess air.

The engine illustrated in FIG. 1 can operate unthrottled over the range of air fuel ratios varying from approximately 120:1 at idling to the illustrated value of 60:1 A ratio of 120:1 represents eight times more air than needed for complete combustion and 60:1 represents four times more air. FIG. 1 is chosen to illustrate an air fuel ratio of 60:1 which is assumed, for the sake of illustration, to be the threshold value of IMEP which does not produce enough NOx in the exhaust to exceed the permissible quantity under emission legislation.

The amount of air transferred from the cylinder into the combustion chamber per unit time increases during the compression stroke. The amount of fuel injected by injector (6) into the air jet emerging from transfer orifice (7) is delivered at approximately constant rate. The resulting air fuel mixture will therefore start off rich and end lean over the compression stroke period. The vortex motion imparted to the mixture is biased in the direction towards the spark plug (9) by the helical ramp (6), so early rich mixture is forced to rotate around the plug. As the vortex becomes more intense it smears the mixture around the periphery of the chamber (5) and centrifugal force compresses it to a thin compacted layer. The molecules of Oxygen and fuel are brought into closer proximity as a result and flame propagation after ignition is very fast.

The engine illustrated in FIG. 1 illustrates how the Merritt Engine works but does not explain any of the two new methods of operation according to the current invention.

The operation of the engine according to this invention is explained by way of an example in FIG. 2. The piston is shown in mid compression stroke at a fuelling rate which produces an I EP value of 80% of maximum value. At this IMEP, it is assumed that the exhaust gases will contain an amount of NOx gases which will require the use of the catalytic converter. The controller will need to eliminate all free Oxygen from the exhaust gas to enable the catalytic converter to function. The controller is programmed to recognize that this happens at this IMEP value by recognizing the total cyclic fuel quantity being delivered to produce this IMEP.

In order to substantially reduce and even eliminate free Oxygen from the exhaust gases the controller needs to use both methods of operation according to the present invention and to apply them simultaneously. The partial throttling method of operation

This method is illustrated in FIG. 2. At the higher end of the IMEP range the controller is programmed to move the throttle valve to a pre-determined partially closed position to reduce slightly the amount of air entering the engine. The reduction of air intake will reduce the amount of available Oxygen to match the amount of fuel being delivered for burning within the combustion chamber to ensure that all or substantially all the Oxygen in the chamber is consumed by combustion. It needs pointing out that the throttle valve is closing when the IMEP of the Merritt Engine is rising which is the exact opposite operation required from a throttle valve in conventional Otto engines.

Rather than snap the throttle valve directly into its partially closed position, the controller can begin slowly to close it at fuelling levels corresponding to IMEP slightly below 80%, when NOx emission is still below legislated limit, so allowing it to reach the correct position when required for action. As the car driver increases IMEP demand above 80% the throttle valve changes direction until it reaches the fully open position at maximum IMEP when the fuel input consumes all or substantially all of the available Oxygen. An Oxygen sensor such as the familiar Lambda sensor can monitor Oxygen presence in the exhaust gas and provide a feed back to the controller in order to effect fine adjustments to the throttle valve position. The need to remove all free Oxygen from the exhaust gases to enable the use of the catalytic converter cannot be achieved by partial throttling alone, the simultaneous application of the other method of the present invention, is required.

The extended fuel injection period (primary) method of operation When the piston reaches TDC at the end of the compression stroke there must remain a small clearance volume between its crown and the cylinder head to avoid damaging contact. This volume is often called bump clearance volume. The design of the Merritt Engine tries to minimize the bump clearance volume in order to maximize the volume of the combustion chamber because all the fuel is delivered for burning within the chamber. An additional method is required to remove the Oxygen from the bump clearance. This additional method is illustrated in FIG. 3.

Because the fuel injector (8) delivers fuel at high pressure inside the combustion chamber and in the opposite direction to the transfer orifice (7), it would appear impossible to deliver fuel to the bump clearance volume without installing a second fuel injector pointing down into the transfer orifice. Such a second injector was proposed in an earlier Merritt Engine invention for the purpose of increasing power density. It can be seen in the patent publication WO 2007/080366 in FIG. 8. The primary method according to the present invention offers a much simpler solution to this problem which does not require a second fuel injector per cylinder. To operate this method the controller modifies the timing of fuel delivery whilst controlling the total fuel quantity required per engine cycle. Normally in the Merritt Engine fuel is injected during the compression stroke in order to form the stratified charge in the combustion chamber and Injection stops before the end of the compression stroke and before spark ignition occurs. The method of operation according to this invention requires to prolong fuel injection either until after the spark ignition event or until after the beginning of the expansion stroke or preferably after both events. The capability to inject fuel against post ignition pressures is made possible by the gasoline direct injection system, called GDI. The extended injection period can be a continuation of a prolonged uninterrupted first injection period or it can be achieved in two or more distinct actuations of the fuel injector if time allows.

This method of operation enables transfer of fuel from the fuel injector's outlet location in combustion chamber (8) into the cylinder (2) for the purpose of consuming Oxygen trapped within the bump clearance volume. The transfer is carried out by entraining some of the fuel into the dense gas which begins to flow towards the cylinder either when the expansion stroke starts or after spark ignition occurs and always after both events take place. After ignition such dense gas is very hot possibly still burning. FIG. 3 illustrates expanding gas flowing into the cylinder through the transfer orifice (7) and into cylinder (2). The hot burning gas will entrain the fuel, vaporize it and divert it away from the combustion chamber (5) into the cylinder (2). It will most probably also ignite to burn with bump clearance Oxygen because the application of this method will take place at the higher end of IMEP. The extra amount of fuel delivered and diverted during the prolonged injection period suffice to use up all the free Oxygen trapped in the bump clearance within the cylinder in order to meet the objective of Oxygen free exhaust. If the ignition of the fuel delivered during the extended injection period fails a second ignition means can be used to intercept the mixture as it enters the cylinder. The second ignition means is not illustrated in the diagrams but it can be a glow plug which can be continuously energized.

This method of operation effectively allows the engine controller to operate two combustion events, the first inside the combustion chamber and the second inside the cylinder.

The two new methods according to this invention namely the extended fuel injection and partial throttling need to be used together at the higher end of IMEP in order to enable the use of a catalytic converter to remove NOx from the exhaust. However the extended fuel injection method when used on its own can also offer four other operational capabilities which enhance engine performance.

Additional Operational Capabilities

These can be applied by the engine controller whilst the engine is operating. Some of the capabilities are unusual in other internal combustion engines.

1. It allows the engine controller to limit the peak pressures produced at high IMEP operations;
2. It allows the engine controller to increase the maximum power density when
operating at maximum IMEP, by providing fuel to burn with the Oxygen trapped in the bump clearance.
   3. It allows the engine controller to choose to increase the amount of heat discarded in the exhaust gases if such extra heat is required for cabin heating inside a car;
   4. It allows the engine to discard the partial use of throttle in countries which do not impose NOx limits whilst retaining the first three additional capabilities listed above or by restricting maximum IMEP subject to car driver's control it allows a car to dispense with the use of a catalytic converter whilst benefiting from maximum thermal efficiency and minimum exhaust pollution at the expense of reduced power density.

First Capability:

The vortex tube type gas movement in the combustion chamber, forces fuel and air molecules to be compressed nearer together against its periphery by centrifugal force. As a result the combustion process in the Merritt engine is extremely fast compared with diesel and even Otto engines combustion speeds. At moderate engine speeds the Merritt Engine can operate nearly on the constant volume air cycle which delivers the highest thermal efficiency of unthrottled car engines in common use. However at the higher IMEP range and lower engine speeds very fast combustion can cause excessive peak pressures in the cylinder which can even damage the piston. The extended fuel injection method according to this invention enables the late fuel delivery to burn inside the cylinder after the piston moves away from TDC to expose an increased cylinder volume so reducing the peak cyclic pressures. At lower engine speeds it may be preferable to operate the fuel injector according to this method aspect twice in quick succession to cause two such combustion events within the cylinder, alternatively the rate of fuel injection per unit time may be reduced by the controller to enable one long injection event astride TDC.

Second Capability:

When extended fuel injection is exercised by the controller at high IMEP operations the ignition of the late fuel delivery by very hot gases escaping into the cylinder is very likely to occur without the need to activate a second ignition means. Also under these conditions it is likely that NOx control will also be needed in some countries so the first capability will also become operational bringing the throttle valve into play. When used on its own, even when the engine is turbocharged, that method aspect can allow the engine to consume all available Oxygen for combustion so maximizing power output.

Third Capability:

Deliberate increase of heat energy rejected into the engine exhaust will understandably lower thermal efficiency of the engine. However engines with very high thermal efficiency such as the Merritt Engine are sometimes unable to generate sufficient waste heat to provide cabin heating in cold climates. The amount of heat rejected can be increased by deliberately burning fuel during the expansion stroke. Stratification in the Merritt engine enables burning of fuel with excess air inside the combustion chamber, so removing fuel from that chamber to burn within the cylinder during the expansion stroke is possible to increase the amount of heat rejected with exhaust gases. The third capability may be needed at low to mid-range IMEP values where ignition of the late fuel delivery may require assistance from a secondary ignition means. Such means may need to be located near the transfer orifice exit aperture on the cylinder head. A glow plug is a suitable such secondary ignition means, because it can be energized continuously without pre-igniting the fuel delivered inside the combustion chamber before spark ignition or before the start of the expansion stroke. Alternatively the transfer orifice itself can be thermally insulated to maintain a high temperature for example by a layer of ceramic, which can even be sputtered with a little Platinum catalyst to assist the second ignition event when necessary.

Fourth Capability:

When operating at moderate IMEP and including starting and idling, the Merritt Engine emits very small quantities of NOx which can be below the legal limits for exhaust emissions. The use of the two methods of operation according to this invention can be disabled when operating at such range of IMEP whereupon the engine can then revert to operate as an unmodified and unthrottled lean burn Merritt type engine with very high thermal efficiency and low NOx emission capability. This invention allows the engine controller to recognize when to engage one or both methods of operation, by monitoring the amount of fuel delivered per engine cycle, and act in accordance with a plan which is programmed for automatic engagement and disengagement without interrupting the engine's operation.

The selection can be done by the car's driver by a throw of a switch, or by car manufacturers who can deliberately de-rate engine output IMEP to ensure low emission of NOx and Carbon dioxide, albeit at the expense of reduced vehicle performance.

1. A method of operating an internal combustion engine comprising;
at least one cylinder (2);
a cylinder head to close the cylinder at one end;
a piston located in the cylinder for reciprocating movements therein (1);
an unavoidable bump clearance volume in the cylinder (2) situated above the piston (1) when the piston reaches the end of its compression stroke;
air inlet means communicating with the cylinder (3,10);
exhaust means communicating with the cylinder;
a combustion chamber within the cylinder head having a near end and a far end relative to the cylinder, said chamber being spaced from the cylinder but communicating therewith at its near end;
a transfer orifice (7) communicating with the cylinder (2) and the combustion chamber (5) at its near end positioned to deliver a jet of air into the combustion chamber with a tangential velocity component during the compressions stroke of the piston (1);
means to promote an axial velocity component to swirling air motion within the combustion chamber which is directed towards the far end (6);
fuel injection means (8) communicating with the combustion chamber at its near end arranged to deliver liquid fuel spray towards the far end of said combustion chamber and into the air jet;
at least one ignition means in the region of the far end of the combustion chamber; and
a controller to control the fuel injection process, the ignition process and air intake process;
wherein said method comprises controlled delivery of fuel from the fuel injector (8) outlet into the volume above the piston inside the cylinder (2), after the ignition means (9) ignites fuel in the combustion chamber and/or after the piston (1) commences its expansion stroke.

2. A method as claimed in claim 1 wherein the combustion chamber is configured to induce or enhance swirling flow of air when delivered therein.

3. A method as claimed in claim 1 or 2 wherein the combustion chamber operates as a vortex tube.

4. A method as claimed in any preceding claim in which the combustion chamber is cylindrical, conical or part-conical.

5. A method as claimed in any preceding claim simultaneously applied together with a secondary method comprising controlled partial restriction of said air inlet means.

6. A method as claimed in any preceding claim, wherein the engine controller is enabled to inject fuel during both the compression stroke and during the early part of the expansion stroke, to enable transfer of fuel into the bump clearance volume by expanding gases flowing from the combustion chamber (5) towards the cylinder (2).

7. A method as claimed in any preceding claim wherein a second ignition means, such as a glow plug, is provided in the region of the exit from transfer orifice (7) in the cylinder (2).

8. A method as claimed in any one of claims 5 to 7 wherein the air inlet means (3) includes a throttle valve (10) operable from fully open to partial closure.

9. A method as claimed in any one of claims 5 to 8 wherein both methods are applied when the cyclic fuel quantity is determined to cause unacceptable quantity of Nitrogen Oxides in the engine exhaust gas and the use of a catalytic converter is required.

10. A method as claimed in any one of claims 6 to 9 wherein the method is applied when the cyclic fuel quantity is determined to cause excessive peak cylinder pressure after ignition.

11. A method according to any preceding claim applied when a need arises to increase the amount of waste heat in the exhaust.

12. A method as claimed in any preceding claim in which the surface of the transfer orifice (7) is selected from one or more of the following: made of material of poor thermal conductivity, covered with thermal insulation material; such as ceramic, or is covered with catalytic material such as platinum.

13. A method as claimed in any preceding claim in which the fuel injector (8) is controlled to deliver fuel in more than one pulse during one engine cycle, such as in two pulses or three pulses and wherein one or two such pulses are delivered into the cylinder region.

14. An engine as defined in claim 1 provided with a controller adapted to enable its operation in accordance with any preceding claim.

15. An engine as claimed in claim 14 in which the controller is able to select or de-select either or both methods of such operation.

16. An engine as claimed in claim 15 in which the selection is effected based on the amount of fuel delivered per engine cycle and without interruption of engine operation.

17. A motor vehicle fitted with an engine as defined in any one of claims 14 to 16.

18. A motor vehicle according to claim 17 fitted with an exhaust catalytic converter.

19. A method of operating an engine as claimed in any one of claims 1 to 13 substantially as herein described.

20. A method of operating an engine as claimed in any one of claims 1 to 13 substantially as herein illustrated.

21. An engine as claimed in any one of claims 14 to 16 substantially as herein described.

22. An engine as claimed in any one of claims 14 to 16 substantially as herein illustrated.

23. A motor vehicle as claimed in claim 17 or 18 substantially as herein described.
